(19) United States
(12) Patent Application Publication
(10) Pub. No.: US 2013/0004390 A1
(43) Pub. Date: Jan. 3, 2013

(54) DECONTAMINATION ARRANGEMENT AND METHOD

(75) Inventors: Christoph Von Stenglin, Radolfzell (DE); Jürgen Hauk, Freising (DE)

(73) Assignee: METALL + PLASTIC GMBH, Radolfzell (DE)

(21) Appl. No.: 13/521,497

(22) PCT Filed: Jan. 13, 2010
(86) PCT No.: PCT/EP2010/000135

§ 371 Date: Sep. 13, 2012

(51) Int. Cl. B01D 53/00; B01D 51/10

(52) U.S. Cl. 423/210; 422/120; 422/122

(57) ABSTRACT

A decontamination arrangement is disclosed for use in pharmaceutical applications. The decontamination arrangement includes a space to be decontaminated, which may be an isolation space, and a cleaning device designed for extracting gaseous and/or vaporous decontaminants, in particular hydrogen peroxide, from the air in the space. The cleaning device is configured so that the air in the space circulates through it by means of at least one fan. A method for removing gaseous and/or vaporous decontaminants from a space is also disclosed.

### FIELD OF THE INVENTION

The invention relates in general to decontamination devices and methods, and more particularly to devices and methods for decontamination using decontamination agent vapor.

### BACKGROUND

An isolator for pharmaceutical applications is known from EP 0604925 B1. This isolator comprises a manipulator space to be decontaminated, above which a “circulating air generator space” comprising a circulating air fan is disposed. The space to be decontaminated is equipped with double-glazed panes, between which a flow duct is formed. This makes it possible for ambient air to be circulated between the manipulator space and the circulating air space using the circulating air fan during the decontamination process. For decontamination, hydrogen peroxide steam is normally used, and is generated by means of a hydrogen peroxide vaporizer. The vaporizer is normally arranged in a line that runs from the space to be decontaminated—so as to aspirate the air enriched with decontaminant steam—and runs back into the space to be decontaminated in a region downstream of the vaporizer so as to release the air enriched with decontaminant into the space to be decontaminated.

The previously described decontamination device has a fresh air connection, through which conditioned (i.e., dried and heated or cooled) fresh air can be fed so as to blow decontaminant out from the space to be decontaminated once decontamination has been performed. In this way, the device flushes the space. This “flushing” requires a considerable amount of time, which may be from three to ten hours depending on the size of the isolator and the desired (minimum) decontaminant concentration to be achieved, for example of 1 part per million (ppm) or less. The fresh air conditioning devices used in practice comprise a feed air fan (a fresh air fan), which is normally designed so that an air change rate of approximately 150 times per hour can be achieved in the space to be decontaminated and in all spaces in fluid connection thereto. For example, the fresh air fan can feed a volume 150 times the volume of the space per hour.

Known decontamination arrangements in the exhaust air duct are currently provided with a catalytically acting purification device, which, during the flushing of the space to be decontaminated, removes decontaminant from the air in the space before it is discharged into the ambient surroundings, thus protecting the environment. The purification device consists of a catalyst, which, in turn, consists of MnO₂ balls provided as bulk material.

One drawback of the known decontamination arrangements is the long flushing time (i.e., purification time) required in order to reduce decontaminant concentration to a desired level in the air drawn from the space to be decontaminated.

### SUMMARY

Proceeding from the above-described prior art, an object of the invention is to provide an improved decontamination arrangement, with which it is possible to reduce the decontaminant concentration in the air in the space to be decontaminated, in a shorter period of time than has heretofore been possible. A further object is to provide a decontamination method which can reduce the above-mentioned period of time. In some embodiments, energy consumption is also reduced as compared to prior methods and arrangements.

In general, this object is achieved in some embodiments where a purification device is arranged so that the air in a space to be decontaminated can be circulated through the purification device using at least one fan. With regard to a general method, the object is achieved by circulating the air in the at least one space to be decontaminated through a purification device using a fan, where the decontaminant is removable from the air in the space by means of the purification device. In some embodiments the decontaminant is catalytically removable.

Advantageous developments of the invention are disclosed in the dependent claims. All combinations of at least two features disclosed in the description, the claims and/or the figures fall within the scope of the invention. To prevent repetition, features disclosed in accordance with the apparatus are also understood to be disclosed and claimed in accordance with the method. Features disclosed in accordance with the method are likewise to be understood to be disclosed and claimable in accordance with the apparatus.

In principle, it is possible to minimize the time required to reduce the decontaminant concentration to a desired level by providing an accordingly dimensioned fresh air conditioning device. However, this would be associated with increased installation costs and spatial requirement for the larger installation and also with considerably higher energy costs, since a substantially greater amount of air would have to be conditioned, that is to say dried to the desired humidity and heated or cooled to the desired temperature. To avoid these drawbacks, the invention includes placing a preferably catalytically acting purification device in a decontamination arrangement according to the invention in such a way that, once decontamination is complete, the air in the space to be relieved of the decontaminant present therein is circulated through the purification device by means of a fan. Flushing is thus not carried out with fresh air, or at least not only with fresh air, but with the air from the space to be decontaminated initially still being charged with decontaminant. This air is fed multiple times through the purification device, whereby the decontaminant concentration is reduced each time. A fan is preferably used to circulate the air from the space to be decontaminated and is larger (i.e., more powerful) than the fresh air supply fan so as to reduce the flushing time further. As will be explained in greater detail below, the fan is preferably not a fan that is to be provided in addition, but rather may be a circulating air fan, which, in many cases, is already installed for the space, and which is generally designed in the case of isolator applications in such a way that a constant air flow rate of 0.45 meters/second (m/s) can be achieved with the operation of the isolator. The invention thus reduces the flushing time without requiring a larger fresh air conditioning device, since the circulated air from the space to be decontaminated will already be conditioned. Where necessary, fresh air is additionally fed during the flushing process by a fresh air feed line, which is provided where necessary by circulating the air from the space to be decontaminated through the purification device so as to maintain a specific required static air pressure in the space to be decontaminated, (e.g., in an isolator space), and/or so as to further minimise the flushing time. Where necessary, excess air is released into the ambient surroundings through an exhaust air line provided additionally with a purification device as required. In particular in the case of locks to be decontaminated, it is also possible, during the flushing process, to dispense with a fresh air feed and/or a discharge of air from the space to be decontaminated into the ambient surroundings.

As previously noted, it is preferable that the purification device is a catalyst or that the purification device comprises a catalyst. If a hydrogen peroxide steam is used as a decontaminant, it has been proven to be preferable to use MnO₂ or palladium as a catalyst, with which the decontaminant can be chemically cleaved. In principle, it is possible, depending on the type of decontaminant used, to use purification devices based on other operating principles. It is essential that the gaseous and/or vaporous decontaminant present in the air in the space to be decontaminated is made safe, that is to say is either cleaved or bonded or converted in such a way that it is safe for the respective, preferably pharmaceutical, application.

It is particularly expedient, for embodiments in which the decontamination arrangement comprises an “isolator”, if the purification device is arranged in a circulating air generator space is arranged above the actual space to be decontaminated. The circulating air generator space is a fan serving as a circulating air fan, with which an airflow, preferably a laminar airflow, can be generated during normal operation of the space to be decontaminated. In some embodiments, flow is from top to bottom and is at a flow rate of 0.45 m/s. In apparatuses or spaces to be decontaminated which are designed differently, for example in locks for feeding contents to be packaged, pharmaceuticals, etc. to a space to be decontaminated, it is possible to arrange the purification device in a flow duct (e.g., a circulating air duct), in some cases together with the fan, where the flow duct is arranged so that air provided with decontaminant is aspirated from the space to be decontaminated, in particular the lock, and the at least partially purified air can be delivered back into the space to be decontaminated. The flow duct is, in some embodiments, a bypass. In other embodiments the flow duct is a bypass between a fresh air line for feeding fresh air into the space to be decontaminated and an exhaust air line for discharging air from the space to be decontaminated into the ambient surroundings. In preferred embodiments, both the fresh air line and the exhaust air line can each be closed at a point so that the air to be purified can be circulated through the bypass, preferably without the air in the space to be decontaminated escaping through the fresh air line to the fresh air conditioning device and/or through the exhaust air line into the ambient surroundings.

As previously noted, it is preferred if the fan used to circulate the air to be purified through the purification device is a circulating air fan, which is typically already part of the ventilation system for the space, and which is typically laminar, during operation of the space to be decontaminated. In this way, an additional, separate, fan is not required, thus minimizing installation costs.

For embodiments in which the decontamination arrangement comprises an isolator, for example biotech or pharmaceutical applications, it is preferable that a high-efficiency particulate air filter, for example a “HEPA filter” or an “ULPA filter,” be arranged downstream of the fan, which may serve as a circulating air fan, in the direction of flow. Thus, arranged, during operation of the apparatus (e.g., the isolator), the circulated air from the space to be decontaminated is purified of any particulate matter which may still be present before flowing into the space to be decontaminated, which may be a manipulator space. It is preferable if the purification device, which in some embodiments may be functioning catalytically, is arranged upstream from the high-efficiency particulate air filter so that decontaminant can diffuse into the high-efficiency particulate air filter from the direction of the space to be decontaminated (from below). In principle, it is possible to arrange the purification device upstream from the fan so that the fan sucks the air from the space to be decontaminated through the purification device. However, it is most preferable that the purification device be arranged between the fan and the high-efficiency particulate air filter, preferably in a flow duct which runs from the circulating air generator space and which runs into the space to be decontaminated or into a region (i.e., an intermediate space) above the space to be decontaminated, and in particular into a region above a membrane (explained below in greater detail) for generating a laminar airflow, in particular directed from top to bottom. It is also preferable that at least one feed line for feeding decontaminant is arranged in such a way that the previously mentioned purification device is bypassed when the decontaminant is fed, so as to prevent freshly fed decontaminant from being eliminated before the decontamination phase is complete. The at least one feed line preferably runs above the membrane so that the fed gaseous and/or vaporous decontaminant is distributed uniformly therethrough and reaches the space to be decontaminated in a uniformly distributed manner. In some preferred embodiments, a plurality of feed lines are provided for feeding decontaminant so as to bypass the purification device. With the invention, should a region between the purification device and the high-efficiency particulate air filter not be sufficiently decontaminated, decontaminant is fed directly into a region between the purification device and the high-efficiency particulate air filter by means of a branch line from at least one feed line.

It is particularly expedient, in particular for the design of the decontamination arrangement as an isolator, if a membrane, for example a screen printing mesh, is arranged downstream of the high-efficiency particulate air filter. In some embodiments, the membrane is located directly above the space to be decontaminated, which, in some embodiments is a manipulator space. The membrane may convert the airflow generated by the circulating air fan into laminar flow, preferably having a flow rate of approximately 0.45 m/s. It is particularly preferable if the at least one feed line used for feeding the decontaminant ends in a region above the membrane so as to avoid (i.e., bypass) the purification device.

It is particularly expedient if the decontamination arrangement comprises a feed device for feeding the gaseous and/or vaporous decontaminant. This feed device may comprise means for generating the gaseous and/or vaporous decontaminant, in particular a vaporizer, preferably formed as a flash vaporizer, with which liquid decontaminant can be vaporised to generate decontaminant steam. The feed device preferably runs via a feed line into the space to be decontaminated and/or above a membrane provided for generating laminar airflow. An exhaust air line may also be provided, through which air from the space to be decontaminated can be discharged, for example, into the ambient surroundings. It is particularly expedient, during the conditioning phase, during which the space to be decontaminated is enriched with decontaminant until a desired concentration is reached, if the exhaust air line is opened and decontaminant, in particular vaporous decontaminant, is fed with the aid of compressed air from pressure tanks or pressure cylinders or with the aid of conditioned fresh air. In other words, it is preferable to use compressed air or fresh air decontaminant conditioning, that is to say if air from the space to be decontaminated is not aspirated and enriched, so as to at prevent condensation of decontaminant in the space to be decontaminated. During the conditioning phase, a valve and/or an exhaust air fan in the exhaust air line may be controlled in such a way that a desired air pressure is maintained in the space to be decontaminated. In addition, or as an alternative, the control of the amount of exhaust air, to set a required pressure in the space to be decontaminated, may be carried out during normal operation of the space to be decontaminated. The exhaust air line may be opened during the decontamination phase following the conditioning phase, and decontaminant may be fed at low concentration, where necessary, by means of carrier air.

In a further embodiment of the invention, the decontamination apparatus advantageously includes a fresh air conditioning device. The fresh air condition device may be used for heating/cooling and, where necessary, drying, ambient air (fresh air), wherein the fresh air conditioning device conveys the fresh air into the space to be decontaminated, preferably via a circulating air generator space. With the invention, it is not necessary to provide an over-dimensioned fresh air conditioning device for actual operation in order to achieve shorter flushing times (decontaminant purification times). The fresh air conditioning device is preferably designed in such a way that, in the space to be decontaminated and in all spaces in direct fluid connection to this space, an air change rate of 160 times or less per hour by means of conditioned air is possible with the disclosed device. The fresh air conditioning device may, in some embodiments, be smaller, so that an air change rate of at most 100 times or at most 50 times or less per hour is possible.

As mentioned in the introduction, it is known from the prior art to arrange an MnO₂ catalyst in the exhaust air line (that is to say not with circulating air operation) to clean hydrogen peroxide from the air to be discharged into the ambient surroundings. MnO₂ is normally provided as bulk material in a container, through which the exhaust air can flow. A drawback of the bulk material catalyst is that it involves a comparatively high flow resistance, which requires a greater power of the fan so as to ensure the required flow rate of 0.45 m/s during operation. In a development of the invention, to minimise the disadvantageous flow resistance with maximum effective surface area, the catalyst material is advantageously not provided in the form of bulk material, but rather is provided as a coating on a carrier structure. The carrier structure may be coated with MnO₂ or palladium. The carrier structure may have a maximum surface area so as to provide the greatest possible effective catalyst surface in the smallest space possible. It is particularly preferable if the carrier structure is formed from a metal foam, which is open-pored, wherein the metal foam is coated with MnO₂, in particular electrolytically. In some embodiments, the metal foam is an aluminium foam or a nickel foam. In further embodiments, a manganese sulphate solution is suitable, with the aid of which a manganese dioxide film can be applied electrolytically to the carrier structure, in particular the metal foam surface. The metal foam may consists of 50% nickel, 22% iron, 22% chromium and 6% aluminium. Alternatively, it is conceivable to form the metal foam from 73% iron, 22% chromium and 6% aluminium. To coat the metal foam, the foam may be used as an anode in an electrolyte process, wherein manganese dioxide from a manganese sulphate electrolysis bath is deposited at the anode when a voltage is applied.

In some embodiments the space to be decontaminated is a biotech or pharmaceutical manipulator space, that is to say a space which can be accessed via gloves, which in particular are connected rigidly to the space. In addition or as an alternative, the space to be decontaminated may be a space for the handling of pharmaceuticals and/or a filling space, comprising a filling device for filling pharmaceuticals. The space to be decontaminated may consist of a combination of a manipulator space and a filling and/or handling space, wherein the filling and/or handling space is arranged below the manipulator space. In some embodiments, a circulating air generator space comprising a circulating air fan is located above the manipulator space.

It is particularly expedient if the space to be decontaminated has a volume of at least 0.8 dm³, preferably of at least 1 m³ or 5 m³, particularly preferably of at least 10 m³, even more preferably of at least 20 m³ or more. It is also conceivable to decontaminate and flush an entire building space using the invention.

The invention also includes a method for removing (lowering the concentration) of gaseous and/or vaporous decontaminant, in particular of hydrogen peroxide steam, from a space to be decontaminated, in particular by using a decontamination arrangement (e.g., a decontamination apparatus) as previously described. The invention does not involve flushing the space to be decontaminated with fresh air, or not only with fresh air, but rather to circulate the air from the space to be decontaminated charged with decontaminant through a purification device which is designed to remove decontaminant, at least to a large extent, from the air from the space to be decontaminated. In some embodiments, this removal is achieved using a catalytic process.

In some embodiments, the fan, which may be a circulating air fan for generation of a laminar airflow during operation of the space to be decontaminated, is switched off or remains switched off at least over the majority of a conditioning phase, preferably during the entire conditioning phase, during which the space to be decontaminated is enriched with decontaminant. The same applies during the phase of action, that is to say the actual decontamination phase, during which the decontaminating action of the decontaminant takes hold. Air in the space to be decontaminated enriched with decontaminant is thus actively prevented from being conveyed through the purification device during the aforementioned phases, whereby decontaminant would be removed.

In one embodiment of the method according to the invention, an exhaust air line is opened during the conditioning phase, at least temporarily, preferably over the majority, preferably during the entire period, and ambient air (fresh air), which is conditioned in particular, and/or compressed air, which is filled in particular or generated by a compressor, is/are used instead of air from the space to be decontaminated to inject gaseous or vaporous decontaminant. It is thus preferable to provide “fresh air conditioning” or “compressed air conditioning” with decontaminant, whereby condensation can be minimized.

The invention relates to a device for generating decontamination agent vapor, particularly hydrogen peroxide vapor, comprising an evaporator body, a heating unit for heating the evaporator body and a plurality of feed channels for feeding decontamination liquid to be evaporated, which in a preferred embodiment is a liquid containing hydrogen peroxide. The invention preferably relates to a so-called flash vapor generator, also known as a high-speed vapor generator. The invention further relates to a preferably pharmaceutics-based assembly comprising a space to be decontaminated, particularly an isolator and/or a lock, and a device for generating decontamination agent vapor.

The invention further relates to a decontamination arrangement, in particular for pharmaceutical applications, comprising a space to be decontaminated, sometimes referred to as an isolation space, and a purification device designed to extract gaseous and/or vaporous decontaminants (e.g., particular hydrogen peroxide), from the air in the space. The invention also relates to a method for removing gaseous and/or vaporous decontaminants, in particular hydrogen peroxide steam, from a space to be decontaminated. In one embodiment, this is done by means of a decontamination arrangement designed as described above. In some embodiments, the step of feeding decontaminant into the space to be decontaminated is performed prior to flushing, the method is a combined decontamination/decontaminant removal method.

Further advantages, features and details of the invention will emerge from the following description of preferred exemplary embodiments, given with reference to the drawings.

### BRIEF DESCRIPTION OF THE DRAWINGS

FIG. 1 is a block diagram of the basic structure of an exemplary embodiment of a decontamination arrangement according to the invention;

FIG. 2 shows a decontamination arrangement formed as an isolator, comprising a manipulator space as the space to be decontaminated and a circulating air generator space, likewise to be decontaminated, above the manipulator space; and

FIG. 3 shows a schematic illustration of the basic structure of an alternative decontamination arrangement, comprising a lock, for example, as the space to be decontaminated.

In the figures, like elements and functionally like elements are denoted by like reference signs.

### DETAILED DESCRIPTION

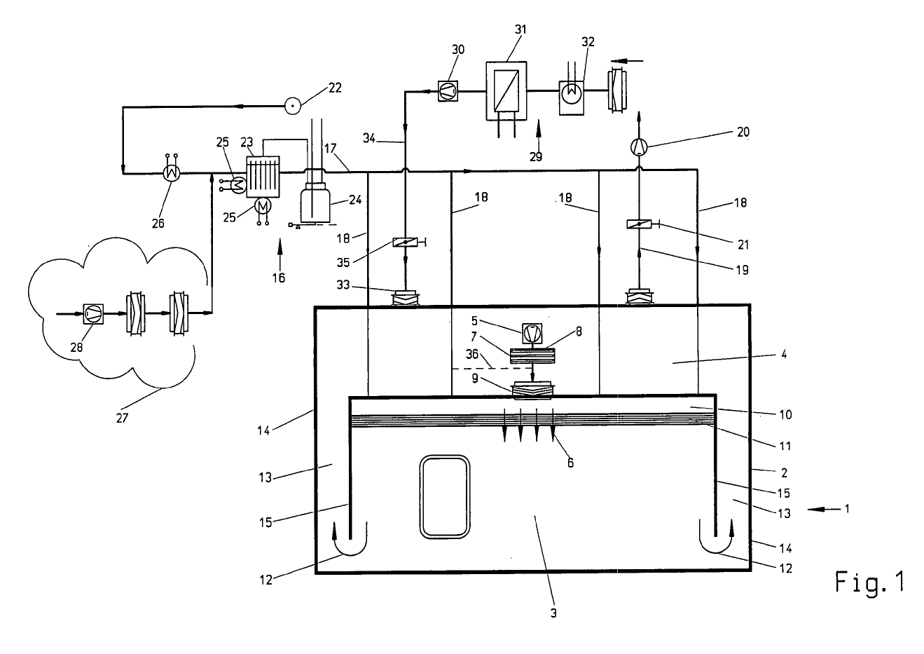

FIG. 1 is a schematic block diagram of the structure of an exemplary decontamination arrangement 1 for pharmaceutical applications. This arrangement comprises an isolator 2 having a space 3 to be decontaminated, which in the exemplary embodiment is shown as a manipulation space which is accessible externally by means of gloves by an operator. Where desired, a filling space comprising a filling device for filling pharmaceuticals can be provided beneath the manipulator space. The manipulator space and the filling space form a space unit to be decontaminated (space 3 to be decontaminated).

A circulating air generator space 4 having a fan 5 serving as a circulating air fan may be located above the space 3 to be decontaminated. This circulating air generator space is designed in such a way that, with the aid of the fan 5, a uniform airflow 6 having a flow rate of approximately 0.45 m/s can be generated from top to bottom in the space 3 to be decontaminated during normal operation. The fan generates a turbulent flow, which is converted into a laminar flow by means of a membrane (as will be explained in greater detail later), where desired, in combination with a high-efficiency particulate air filter.

A purification device 7 may arranged downstream of the fan 5 in the direction of flow. The purification device 7 may consist of a carrier housing for a catalyst 8—an MnO₂ catalyst in the illustrated exemplary embodiment for cleaving hydrogen peroxide steam. The catalyst 8 may be formed by a metal foam coated by means of MnO₂ so that there is low flow resistance when air flows through the catalyst 8 and the catalyst 8 is formed with a small volume.

A high-efficiency particulate air filter 9, for example a HEPA filter or a ULPA filter, may be arranged downstream of the purification device 7 in the direction of flow. The airflow generated by the fan reaches an intermediate space 10 after the high-efficiency particulate air filter 9, where the intermediate space is defined from beneath by a membrane 11. In some embodiments, the membrane 11 may be made of a screen printing mesh. The membrane 11 may convert the airflow into laminar airflow 6, which has the aforementioned flow rate of 0.45 m/s during operation. The air thus flows downwardly in the space 3 to be decontaminated, and from there upwardly in the direction of arrows 12 into flow ducts 13, which are formed between isolator walls 14, for example formed by glass plates, and inner transparent plates 15, which may be made of glass, arranged parallel to the isolator walls 14 and spaced at a distance therefrom. The air from the space to be decontaminated conveyed by the fan 5 can thus flow back into the circulating air generator space 4 through these flow ducts 13, where the air is then aspirated again by means of the fan 5. The air from the space to be decontaminated is thus circulated through the purification device 7 during operation of the fan 5.

So as to use and operate the isolator 2, more specifically the space to be contaminated, as intended, it must first be decontaminated. To this end, a feed device 16 is provided, with the aid of which gaseous and/or vaporous decontaminant can be fed, in particular mixed with carrier air. The feed device 16 comprises a central supply line 17, which in the exemplary embodiment shown serves as a distributor line. In the exemplary embodiment, a total of four feed lines 18 exit from the supply line 17 and run into the intermediate space 10 above the membrane 11, bypassing the purification device 7. The decontaminant is thus distributed in the intermediate space 10 during the conditioning phase, passes downwardly through the membrane 6 and can then flow upwardly to an exhaust air line 19 in the direction of arrow 12 through the flow ducts 13. In some embodiments, the exhaust air line is open during the conditioning phase, such that the isolator is enriched with decontaminant. An exhaust air fan 20 can be provided in the exhaust air line 19 and can be used to selectively suck up air from the isolator 2. The pressure of the air from the space to be decontaminated may be controlled via the exhaust air fan 20 in the exhaust air line 19. Since air from the space to be decontaminated can escape through the exhaust air line 19, the decontaminant distributes in the actual space 3 to be decontaminated and also uniformly in the circulating air generator space 4. Since, during the conditioning phase, air from the space to be decontaminated is discharged through the exhaust air line 19 (using, where desired, the exhaust air fan 20), condensation of the decontaminant over the peripheral walls is prevented.

In the exemplary illustrated embodiment, the feed device 16 comprises a compressed air source 22 for carrier air (e.g., a compressed air cylinder), and a vaporizer 23, with the aid of which decontaminant, in this case hydrogen peroxide, fed from a storage container 24, can be vaporised. The vaporizer 23 has corresponding heaters 25. A preliminary heater 26 is arranged upstream of the vaporizer 23 so as to heat the compressed air (carrier air) suitably.

In exemplary alternative embodiments, the feed device 16 may be formed as described below and as denoted by reference sign 27. In this case, the main difference with the prior embodiments is that the feed device 27 has a supply fan 28 for feeding fresh air, as opposed to the feed device 27 of the previous embodiments. This fresh air may be suitably conditioned, that is to say dried and heated/cooled. A fresh air conditioning device (which will be explained in greater detail later) can also be arranged downstream of the vaporizer 23, either connected directly to the fresh air line or bypassing the fresh air line. A separate conditioning device can thus be omitted.

Decontaminant may first be fed during a conditioning phase, during which the exhaust air line 19 is opened, irrespectively of the carrier air (compressed air or conditioned fresh air). Following the conditioning phase, once the decontamination phase is complete (i.e., where the desired decontaminant concentration is set or reached), the feed device 16 or 27 is switched off or disconnected, and decontaminant is removed from the space 3 to be decontaminated. To this end, the fan 5, which was switched off during the conditioning phase and the decontamination phase, is switched on so that the air in the space 3 is circulated through the purification device 7, thus reducing the decontaminant concentration by the catalytic action of the catalyst 8. Once the desired minimal concentration is reached, for example 1 ppm, 0.5 ppm, or less, it is possible to switch to normal operation of the space 3 to be decontaminated.

In FIG. 1, a fresh air conditioning device 29 is shown, which, in the illustrated embodiment, is a fresh air fan 30. The fresh air fan 30 may be configured to facilitate an air change rate of 150 times per hour is possible in the isolator. The fresh air can be cooled by means of a cooling device 31 or heated by means of a heating device 32. In some embodiments, the air is dried. The fed fresh air flows into the circulating air generator space 4 via a filter 33 formed as a HEPA or ULPA filter. It can be seen that the fresh air line 34, which leads to the filter 33, can be shut off by means of a valve 35. During normal use, fresh air is fed into the system via the fresh air conditioning device 29 so as to compensate for an unavoidable pressure loss during operation, for example due to leakage points in a filling space, which may exist. Leakage points are in particular unavoidable if goods, for example filled pharmaceutical containers, have to be removed, generally continuously, from the space 3 to be decontaminated. The desired pressure in the isolator 1 may be controlled via the exhaust air fan 20 in the exhaust air line 19.

It will be appreciated that it is not necessary to feed fresh air via the fresh air line 34 during the flushing phase (the circulating air phase), that is, during purification of the air from the space to be decontaminated. However, the flushing process may be accelerated further by using such a fresh air feed.

So as to ensure the flow rate of 0.45 m/s, the fan serving as a circulating air fan during operation may be made larger (for example, at least twice as powerful), and in the exemplary embodiment about five times larger (i.e., five times more powerful), than the fresh air fan 30. Providing a larger fan will provides desirably larger volume flow (e.g., a volume flow which is five times greater) through the purification device 7 as compared to the amount of fresh air which can be fed through the fresh air line 34.

In FIG. 1, an optional branch line 36 is shown. This branch line connects at least one feed line 18 to a region of the flow duct between the purification device 7 and the high-efficiency particulate air filter 9 to ensure that this intermediate region is also decontaminated sufficiently.

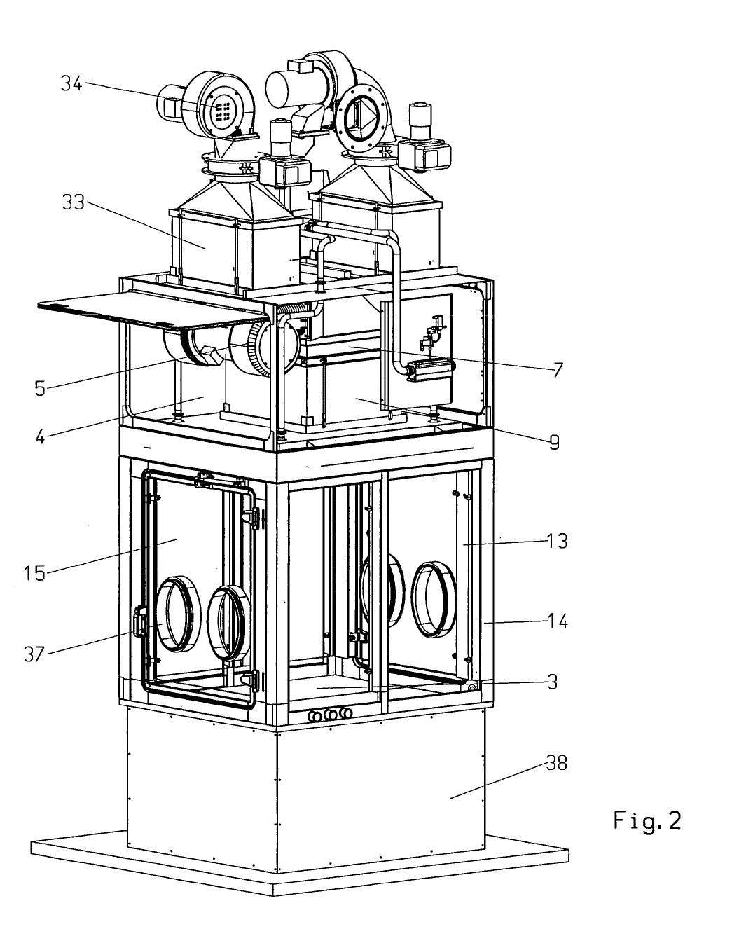

FIG. 2 shows an exemplary structure of an isolator 2. The space 3 to be decontaminated may be formed as a manipulation space and may be accessible by hand via openings 37 by means of gloves (not shown) which are fixed on the isolator and seal the openings 37, as can be seen. Plates 15, which may be glass plates, are located behind the isolator walls 14 formed of glass. These plates 15 may form flow ducts 13, through which air can flow from the space to be decontaminated into the circulating air generator space 4 arranged above. A fresh air line 34 runs into this circulating air generator space via a filter 33. The high-efficiency particulate air filter 9 is located in the circulating air generator space 4. The purification device 7, which may include an MnO₂ catalyst) may be arranged above the high-efficiency particulate air filter, but below a fan 5 formed as a circulating air generator fan that aspirates air from the circulating air generator space 4 and can thus circulate it through the purification device 7.

In the exemplary embodiment shown, the manipulator space sits on a frame 38, indicated schematically. It will be appreciated, however, that an upwardly open filling space, in particular containing a filling machine, or another space, may be provided instead of the frame 38, the space forming part of the space 3 to be decontaminated.

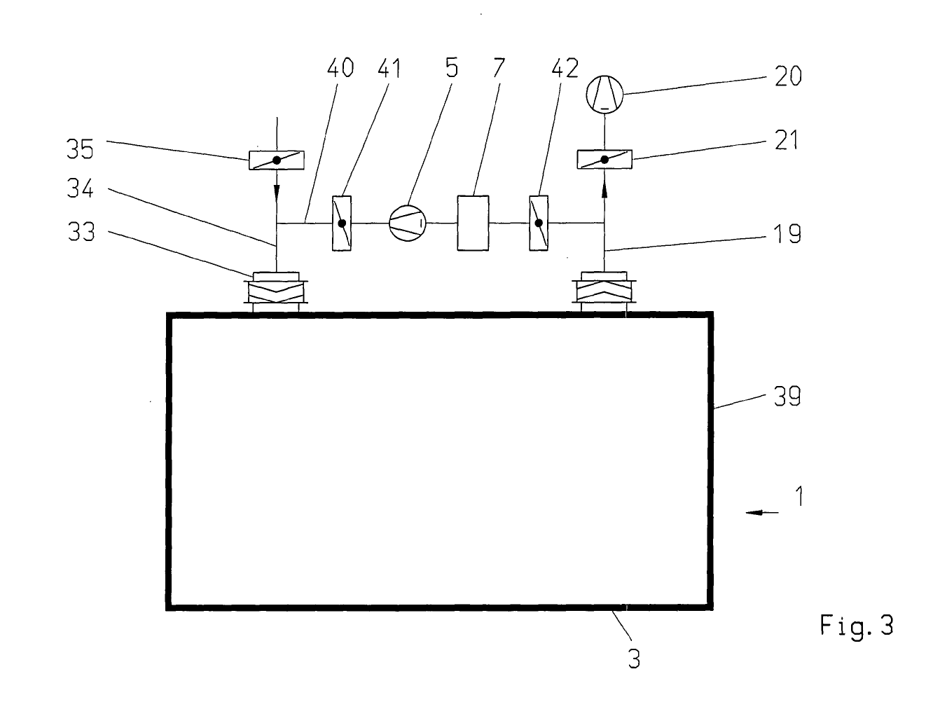

FIG. 3 shows a schematic illustration of the structure of an alternative decontamination arrangement 1, which, in the exemplary embodiment shown, comprises a lock 39 as the space 3 to be decontaminated. A fresh air line 34, which is arranged upstream of a fresh air conditioning device (not shown) runs via a filter 33 (e.g., a HEPA or ULPA filter) into the space 3 to be decontaminated. An exhaust air line 19, which can be closed by means of a valve 21, runs from the space 3 to be decontaminated. A valve 35 formed as a shut-off valve is arranged upstream of the filter 33 in the fresh air line 34. In the direction of flow, the fresh air line 34 is connected downstream of the valve 35 and upstream of the valve 21 via a circulating air line 40 formed as a bypass, in which a fan 5 and a purification device 7, functioning catalytically in this case, are arranged. The circulating air line 40 can be shut off by a valve 42, 41, both before and after the purification device 7 in the direction of flow. The valves 41, 42 are closed during a decontamination phase, and decontaminant is fed, for example, via the fresh air line 34 or a separate feed line (not shown). The valve 21 is open. Where desired, an optional exhaust air fan 20 is additionally operated. After the purification phase following the decontamination phase, at least the valve 21, and preferably also the valve 35, is/are closed, and the air from the space 3 to be decontaminated is circulated through the circulating air line 40 and thus through the purification device 7 so as to extract decontaminant from the air over this path. In some embodiments, this decontaminant extraction is performed by chemical cleaving.

### LIST OF REFERENCE SIGNS

1 decontamination arrangement (decontamination apparatus)
2 isolator
3 space to be decontaminated
4 circulating air generator space
5 fan
6 airflow
7 purification device
8 catalyst
9 high-efficiency particulate air filter
10 intermediate space
11 membrane
12 direction of arrow
13 flow ducts
14 isolator wall
15 plates
16 feed device
17 supply line
18 feed lines
19 exhaust air line
20 exhaust air fan
21 valve
22 compressed air source
23 vaporizer
24 storage container
25 heaters
26 preliminary heater
27 alternative feed device
28 supply fan
29 fresh air conditioning device
30 fresh air fan
31 cooling device
32 heating device
33 filter
34 fresh air line
35 valve
36 optional branch line
37 openings
38 frame
39 lock
40 circulating air line
41 valve
42 valve

1-15. (canceled)

16. A decontamination arrangement for pharmaceutical applications, comprising:
a space to be decontaminated, and
a purification device for extracting at least one of gaseous and vaporous decontaminant from the air in said space,
wherein the purification device is arranged so that the air in said space can circulate through said purification device via at least one fan.

17. The decontamination arrangement according to claim 16, wherein the at least one of gaseous and vaporous decontaminant is hydrogen peroxide

18. The decontamination arrangement according to claim 16, wherein the purification device comprises a catalyst for chemically cleaving the decontaminant.

19. The decontamination arrangement according to claim 18, wherein the catalyst is MnO₂ or palladium.

20. The decontamination arrangement according to claim 16, wherein the purification device is arranged in at least one of a circulating air generator space disposed above the space to be decontaminated, and a circulating air line formed as a bypass between a closable fresh air line and a closable exhaust air line.

21. The decontamination arrangement according to claim 16, wherein the fan is a circulating air fan for generating a circulating air flow during operation of the space to be decontaminated.

22. The decontamination arrangement according to claim 16, wherein a high-efficiency particulate air filter is arranged downstream of the fan in the direction of air flow, and the purification device is arranged upstream of the high-efficiency particulate air filter in the direction of flow.

23. The decontamination arrangement according to claim 22, wherein the purification device is positioned between the fan and the particulate air filter.

24. The decontamination arrangement according to claim 22, wherein a membrane configured to generate a laminar flow is positioned downstream of the high-efficiency particulate air filter in the direction of flow, and wherein decontaminant is feedable into a region above the membrane.

25. The decontamination arrangement according to claim 16, further comprising:
a feed device for feeding the gaseous and/or vaporous decontaminant, and
an exhaust air line for removing excess decontaminant during a conditioning phase.

26. The decontamination arrangement according to claim 25, wherein the feed device is a vaporizer.

27. The decontamination apparatus according to claim 16, further comprising a fresh air conditioning device for conditioning and feeding fresh air, the fresh air conditioning device configured so that a fresh air volume flow can be fed therethrough so as to allow an air change rate of less than 160 times in the space to be decontaminated and in all spaces in fluid connection therewith.

28. The decontamination arrangement according to claim 16, wherein the purification device comprises a carrier structure, coated with a reactive or catalytically active substance, in particular MnO₂ or palladium.

29. The decontamination arrangement according to claim 28, wherein the carrier structure is an open-pored metal foam structure or a lattice structure, and wherein the reactive or catalytically active substance is deposited electrolytically.

30. The decontamination arrangement according to claim 16, wherein the space to be decontaminated includes a space selected from the list consisting of a biological manipulator space, a pharmaceutical manipulator space, a handling space for pharmaceuticals, and a filling space having a filling device for filling pharmaceuticals.

31. The decontamination arrangement according to claim 16, wherein the space to be decontaminated has a volume of at least 0.8 dm³.

32. A method for removing gaseous and/or vaporous decontaminant from a space to be decontaminated using the arrangement according to claim 16, wherein the air in the space to be decontaminated is circulated using a fan through a purification device, with which the decontaminant can be removed catalytically from said air.

33. The method according to claim 32, wherein the fan is off over at least a majority of at least one of a conditioning phase and a phase of action, wherein during the conditioning phase decontaminant is fed, wherein during the phase of action the decontaminating action of the decontaminant takes hold.

34. The method according to one of claim 33, wherein an exhaust air line is opened during at least one of said conditioning phase and a decontamination phase, the exhaust line configured to discharge air enriched with decontaminant from the space to be decontaminated

35. The method according to claim 34, wherein whilst said air is circulated through the purification device, fresh air is additionally fed via a fresh air line.
